(19) United States
(12) Patent Application Publication
(10) Pub. No.: US 2025/0367730 A1
(43) Pub. Date: Dec. 4, 2025

(54) FORMING BUILD MATERIAL LAYERS

(71) Applicant: HEWLETT-PACKARD DEVELOPMENT COMPANY, L.P., Spring, TX (US)

(72) Inventors: Jorge DIOSDADO BORREGO, Barcelona (ES); Marc GARCIA GRAU, Sant Cugat del Valles (ES); Javier NAVARRO GONZALEZ, Sant Cugat del Valles (ES); Sergio PUIGARDEU ARAMENDIA, Sant Cugat del Valles (ES)

(73) Assignee: Peridot Print LLC, Palo Alto, CA (US)

(21) Appl. No.: 19/108,100

(22) PCT Filed: Sep. 2, 2022
(86) PCT No.: PCT/US2022/042458

§ 371 Date: Feb. 28, 2025

(51) Int. Cl. B22F 10/37; B22F 10/14; B22F 10/85; B22F 12/63; B33Y 10/00; B33Y 30/00; B33Y 50/02

(52) U.S. Cl. CPC B22F 10/37; B22F 10/85; B22F 12/63; B33Y 10/00; B33Y 30/00; B33Y 50/02; B22F 10/14

(57) ABSTRACT

A method includes forming build material layers over a build platform of a 3D printing device using a build material recoater to spread build material. At least some layers may be processed according to data describing at least one object to be generated in additive manufacturing to form the at least one object. In some examples, forming the build material layers comprises forming a first subset of consecutive build material layers spreading build material in a first direction for each layer and forming a second subset of consecutive build material layers by alternating between spreading build material in the first direction and a second direction for consecutive layers.

### BACKGROUND

Additive manufacturing processes can produce three-dimensional (3D) objects by providing a layer-by-layer accumulation and solidification of build material according to digital 3D object models. In some examples, printheads can selectively print (i.e. deposit) print agents such as fusing agents or binder agents onto layers of build material within predefined areas that are to become layers of an object being generated. The print agents enable solidification of build material within the printed areas. In other examples, directional energy may be used to provide solidification of selected regions within a layer.

### BRIEF DESCRIPTION OF DRAWINGS

Non-limiting examples will now be described with reference to the accompanying drawings, in which:

FIG. 1 shows an example method of additive manufacturing;

FIG. 2 shows another example method of additive manufacturing;

FIG. 3 is an example method of selecting a recoating mode;

FIGS. 4A and 4B are examples of virtual fabrication chambers;

FIG. 5 is an example of a method for selecting an arrangement of objects in a fabrication chamber;

FIGS. 6 and 7 are examples of apparatus for use in processes for additive manufacturing; and

FIG. 8 is an example of a machine-readable medium in association with a processor.

### DETAILED DESCRIPTION

In some additive manufacturing processes, or 3D printing processes, 3D objects can be formed from layers of build material. In some examples, the build material may be a powder-like granular material, which may for example be a plastic, ceramic or metal powder. The properties of generated objects may depend on the type of build material and the type of solidification mechanism used. According to one example, a suitable build material may be PA12 build material commercially referred to as V1R10A “HP PA12” available from HP Inc. In another example the build material may be a metal powder, for example a stainless steel powder such as “HP 316L SS” or “17-4PH SS”.

In some powder-based additive manufacturing processes, layers of powder or other build material are spread over a build platform by a build material recoater, where they are processed layer-by-layer to form 3D objects.

In some examples, selective solidification is achieved through directional application of energy, for example using a laser, an array of laser diodes, or an electron beam which results in solidification of build material where the directional energy is applied. In other examples, a fusing agent can be printed or deposited onto portions of each build material layer. Heat or other types of energy can be applied to cause the portions of build material to which fusing agent has been applied to melt, coalesce and solidify to form part of a 3D object. In other examples, a binder agent is selectively applied to build material to form a matrix of build material particles bound together by the binder agent. In some examples of such “binder jetting” processes, heat can be applied during printing to at least partially cure and/or dry part of a layer where binder agent has been applied to form, or at least partially form, the matrix. This layer-by-layer process can be repeated until entire objects (or “green parts”) are printed. The fabricated green part can then undergo further post-processing, such as infiltration or sintering. Thus, in some examples, solidification may be a multistage process, in which a green part is formed comprising build material bound in a matrix and solidification is completed in a separate post processing step. In some examples, object generation may be a three stage process, in which layers are printed with a binder agent which may be partially dried after its application. In a subsequent stage, once all the layers have been processed, the collection of layers may be heated as a whole to cure the binder agent, and then the objects may be removed from the bed of build material in order to be sintered at high temperatures to form solid parts.

Using such processes, portions of each build material layer can be caused to combine with, or become bound to, portions of a subsequent layer until a 3D object is formed.

In some additive manufacturing build operations, defects such as cracks, surface roughness or a flaky surface are seen in generated objects. One example of a defect may be referred to as ‘crazing’. Such a defect can appear as cracks or fissures of various lengths and depths in a surface of an object. Crazing has been observed to be particularly problematic in certain downwardly facing horizontal surfaces of objects (based on the orientation of the object during its generation). Such cracks have been observed to begin in initially formed layers in which the object surfaces are generated, and can transfer through to subsequently formed layers, extending for example through the first 10 to 20 layers of such object surfaces. Such object surfaces may also be prone to defects such as being rough and/or flaky.

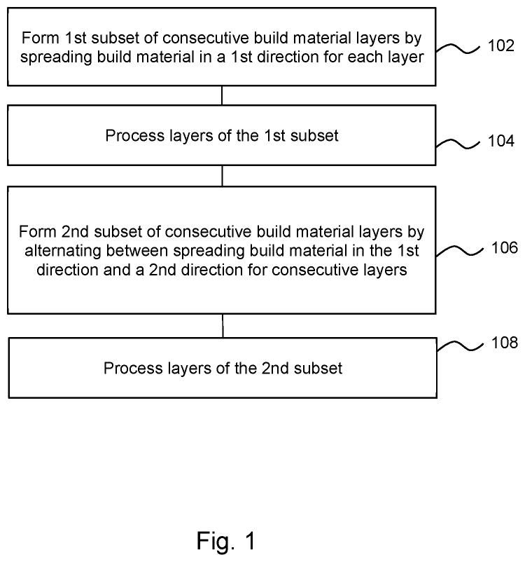

FIG. 1 is an example of a method of additive manufacturing in which build material layers are formed over a build platform of a 3D printing device using a build material recoater. The layers may be formed as part of a build operation for generating at least one object. In some examples, a recoater is implemented as a rotating roller, which may be vibrated in some apparatus. In other examples, a recoater could comprise any other means for sweeping build material across a surface such as a spreading blade, bar or a flexible strip, which may in some cases be vibrated as they spread build material. The recoater may sweep build material over the build platform (i.e. directly on top of the build platform for a first layer and on top of previously formed layers for subsequent layers) from a reservoir of build material provided on at least one side of the build platform. In other examples, a build material dispenser may progressively dispense build material directly onto the upper surface of a print bed as it travels over the print bed, which may be formed by the recoated into a relatively small volume or ‘ridge’ of build material in front of the recoater which is then spread, and compacted and/or flattened by the recoater as it moves over the print bed. In such examples, at least one build material reservoir may be positioned above the build platform.

At least some layers are processed according to a data model (i.e. data representing at least part of one object to be formed in the additive manufacturing process) in order to form at least one object. Processing the layer may comprise applying, for example using inkjet technology or the like, print agents such as binder agents, fusing agents, dyes or colourants, fusion modifying agents (for example agents which reduce the temperature of build material around the perimeter of the layer of the object being formed to inhibit fusion) or the like. In some examples, processing the layer may further comprise applying energy, for example heat or curing energy, in order to cause build material particles to bind or coalesce. In further examples, processing the layer may comprise applying directed energy to selected regions, as described above.

According to the method of FIG. 1, block 102 comprises forming a first subset of consecutive layers of build material by spreading build material over the print bed in a first direction for each layer of the first subset using the recoater. Build material layers of the first subset formed may be processed, for example by applying a print agent, such as a binding or a fusing agent, and/or may have energy applied thereto, if they are to form a layer of a 3D object in block 104. Block 106 comprises forming a second subset of consecutive layers of build material by alternating between spreading build material over the print bed in the first direction and a second direction, using the recoater, for consecutive layers. In other words, in block 106, every other layer is formed by spreading material by moving the recoater in the first direction, and intervening layers are formed spreading build material by moving the recoater in a second direction. Build material layer of the second subsets may also be processed, for example by applying a print agent, such as a binding or a fusing agents, and/or may have energy applied thereto, if they are to form a layer of a 3D object in block 108.

Put another way, according to the method of FIG. 1, some of the layers are formed by spreading build material across the build material in a consistent direction for each of a plurality of consecutive layers, for example for a predetermined number of layers. In another subset of layers, the recoater forms the layers first moving in one direction and then, for the next layer, moving in another (e.g. the opposite) direction, and so on, with the direction in which build material is spread changing for each layer. In some examples, the first and second directions are opposite to one another. These modes of recoating operation may be referred to herein as ‘unidirectional’ and ‘bidirectional’ respectively.

In some examples, the recoater may remain at a consistent height, and the build platform may drop between formation of each layer. In a unidirectional recoating mode, a layer may be formed (and some layers printed with an agent and/or subjected to application of energy) then the build platform may be moved downwards and the recoater may be caused to return to its starting point without spreading build material. In a bidirectional recoating mode, the layer may be formed (and in some layers printed with an agent and/or subjected to application of energy), then the build platform may be moved downwards, and the recoater may return to the starting point while again spreading build material. While in this example, the height of the build platform is changed, in other examples, the height of the recoater above the build platform may be changed instead.

Spreading build material in a consistent direction for each of a plurality of successive layers (i.e., using a unidirectional recoating operation) assists in reducing defects such as crazing. Without wishing to be bound by theory, this may be because the motion of the recoater tends to align build material particles at least somewhat in the direction of movement. Spreading build material in a different, e.g. opposite, direction for an immediately subsequent layer may slightly disturb the build material on the previous layer which is either not bound or fused to surrounding build materials or is yet to fully solidify into an object layer.

However, operation of a recoater in a unidirectional recoating mode may generally result in slower processing times as the recoater will return to its starting position for each layer. Moreover, an additive manufacturing apparatus which is capable of operating in a bidirectional recoating mode may have two reservoirs of build material, each of which supplies build material for one of the recoating directions. Operating such an additive manufacturing apparatus in a unidirectional recoating mode will deplete one reservoir and not the other. Where two separate build material reservoirs are used, they may be dimensioned so that collectively they can provide all of the build material needed to use the maximum height of the fabrication chamber when forming objects. In such cases, if one of the reservoirs is not completely used, the maximum build height cannot be attained. In some examples, additive manufacturing apparatus may not allow refilling during build operations and thus the total build height may be reduced using unidirectional recoating, while in other examples depleting one reservoir more than another may lead to refill operations taking place more frequently, which may reduce manufacturing efficiency.

According to the method of FIG. 1, both modes of operation may be used in a single 3D printing operation, i.e. when forming an object or a plurality of objects together in a single fabrication chamber. Thus, unidirectional recoating may be used selectively to improve the quality of some layers when compared to others, and/or to reduce defects in defect prone portions of the build operation. For example, as will be further set out below, the first subset of consecutive build material layers (i.e. those formed by unidirectional motion of the recoater) may be those layers which form certain downwardly facing horizontal surfaces of at least one object. In other examples, unidirectional recoating modes may be used for objects or portions of objects which are to be formed to a higher quality standard than other objects or object portions (as for example indicated by a user, or in data describing the object to be generated, for example by way of a ‘data tag’ being applied to an object or object portion), to any layer of build material which is to form part of an object (with ‘empty’ layers being formed in a bidirectional manner), or may be selectively applied for some other reason.

While the use of unidirectional recoating may improve object quality for all object portions, as noted above, the use of a unidirectional recoating mode may be used to reduce defects which are seen in the downwards facing surfaces of objects. In some examples therefore, methods may include identifying a downwards facing surface, or base portion, of an object to be generated from data describing the object(s) to be formed. For example, this may be any region of a layer to form part of the object which is above a threshold size and which will overlie build material which is not intended to form part of an object. This may not always be the lowermost portion of the object to be processed.

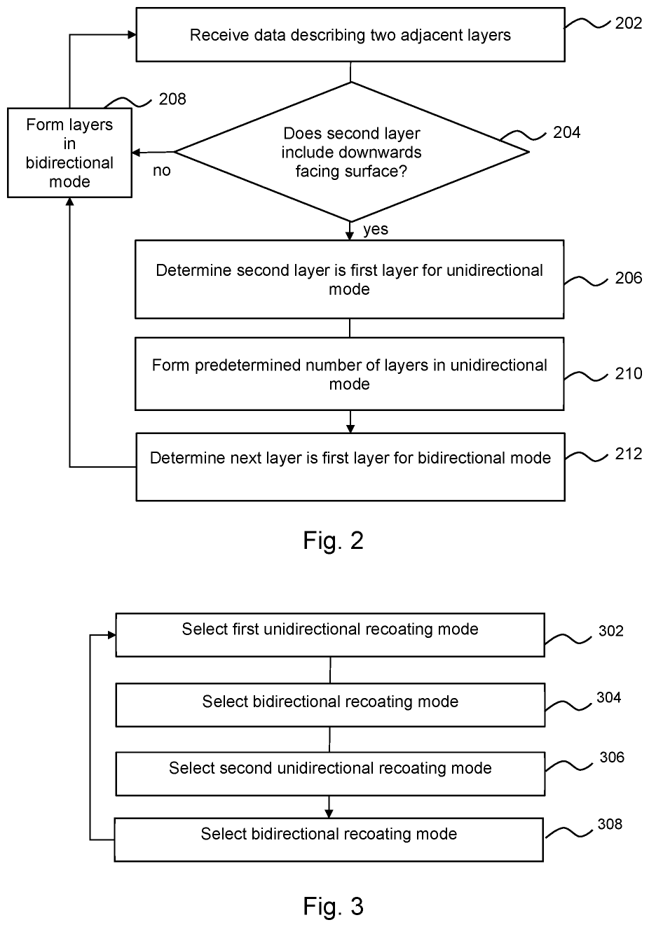

FIG. 2 shows another example of a method of additive manufacturing, and in particular includes an example of a method for identifying a layer for which unidirectional recoating is to be used, for example a layer which may contain a base portion or downwards facing horizontal lower surface as set out above.

The method comprises, in block 202, obtaining, from data describing at least one object to be generated in additive manufacturing in a plurality of layers, data describing an intended content of a first layer and a second layer, wherein the second layer is to be formed directly on top of the first layer (i.e. the layers are adjacent).

As mentioned above, 3D printers generate objects based on structural design data. This may involve a designer generating a three-dimensional model of at least one object to be generated, for example using a computer aided design (CAD) application. The model may define the solid portions of the object(s). In some examples, the model(s) are arranged in a virtual fabrication chamber, representing their intended position within a fabrication chamber of a 3D printer once a build operation is completed. The fabrication chamber defines, or encloses, a build volume in which objects are to be generated.

To generate three-dimensional object(s) from the model using an additive manufacturing system, model data can be processed to generate slices of parallel planes or slices of the model. Each slice may define or describe which portion(s) of a respective layer of build material are to form part of the object (e.g. coalesce, or be bound together) by the additive manufacturing system.

The method of block 202 may therefore comprise receiving two such slices. In other words, such slices provide the data describing the intended content of the first layer and the second layer. In some examples, each slice may be rasterised into pixels (which may also be referred to as voxels as they represent volumetric space, having the depth of the layer of build material). Each pixel may be associated with a property, for example whether that pixel corresponds to part of an object to be formed, or if the pixel corresponds to part of the build volume which is to remain as granular material or otherwise unsolidified. Other properties, such as colour, conductivity, density or the like may also be specified on a pixel-by-pixel basis.

For completeness, in some examples, additive manufacturing control instructions may be derived from such slices. In some examples, such control instructions may specify an amount of print agent to be applied to each of a plurality of locations on a layer of build material. An amount of print agent (or no print agent) may be associated with each of the pixels. For example, if a pixel relates to a region of a build volume which is intended to form part of an object, additive manufacturing control instructions may be derived to specify that fusing or binder agent should be applied to a corresponding region of build material in object generation. If however a pixel relates to a region of the build volume which is intended to remain unsolidified, then additive manufacturing control instructions may be derived to specify that no agent, or an agent to inhibit solidification, may be applied thereto, for example to cool the build material. If a pixel relates to a region of the build material which is intended to have a predetermined color, then at least one colorant (in some examples in combination with a fusing agent) may be applied thereto. In addition, the amounts of such agents may be specified in the derived instructions and these amounts may be determined based on, for example, thermal considerations and the like. In other examples, additive manufacturing control instructions may specify how to direct directed energy, or how to place a different agent, e.g. a curing agent or the like.

Returning to the method of FIG. 2, block 204 comprises determining if the second layer comprises a downwards facing surface. In some examples, it may be determined if the downwards facing surface is at least a threshold size as larger surfaces may be associated with a greater risk of defects in some cases. For example, block 204 may comprise determining if the area to be solidified in the second layer is greater than the area to be solidified in the first layer by more than a threshold amount. This may therefore allow, for example, identification that a downwards facing horizontal surface of an object is being formed, as it identifies a pair of layers in which the second layer to be formed has substantially more area to form part of the object than a previous layer. In other examples, the comparison may be a pixel-wise comparison and a number of pixels which are not to form part of the object in the first layer and are below pixels which are to form part of an object in the second layer may be determined and compared to a threshold. In some examples, the number of pixels in a group of contiguous pixels meeting this condition may be determined, so that a downwards facing surface which is at least a threshold size may be identified.

If the condition of block 204 is met (i.e. the second layer comprises a downwards facing horizontal surface), the method progresses to block 206, which comprises determining that the first layer is a last layer in the second subset and the second layer is a first layer in the first subset. For example, if the area to be solidified increases by more than the threshold amount between one layer and the next layer to be formed, the build operation may switch from operating in a bidirectional recoating mode to operating in a unidirectional recoating mode.

It should be appreciated that the term ‘downwards facing horizontal surface’ refers to a surface of an object in its intended orientation of manufacture. This may be different from the intended orientation during use. Moreover, the object itself may have any number of surfaces. Where a significant portion of a surface is aligned with a layer, whether or not part of that object has already been processed, it may be appropriate to use unidirectional recoating of the build material recoater for those layers. Thus, the method set out in FIG. 2 allows unidirectional recoating to be adopted for parts of an object which are not the lowermost part of the object being processed. Rather, may identify those layers which are likely to be associated with defects such as crazing.

In other examples, rather than being determined by analysis of two adjacent layers, a switch from a bidirectional recoating mode to unidirectional recoating mode may occur under the control of the user. For example, a user may tag a layer to be processed using the unidirectional recoating mode whereas previous layers may be processed using the bidirectional recoating mode. In other examples, an object model, or portion thereof, may be associated with a data tag indicating that a unidirectional recoating mode should be adopted for generating the associated object/object portion. In other examples, there may be no threshold applied, and bidirectional recoating may be used when the layer is empty of any object portions, whereas unidirectional recoating may be used in any layer which is intended to form part of an object. This may allow the empty layers, where object quality is not a concern, to be formed more quickly.

As noted above, in some examples, block 204 may comprise considering a number of pixels in data characterising a region to form part of an object in the first layer and a number of pixels in data characterising a region to form part of an object in the second layer. For example, this may be compared to a predetermined threshold, or to a factor (for example, if the number of pixels is X times higher in the second layer than the first layer, where X is a number), or some other predetermined measure. However, in other examples, block 204 may comprise comparing a difference in an area to be solidified within each layer to a threshold for example with reference to a unit measurement, such as an area in square millimetres or the like. In another example, block 204 may comprise comparing a difference in an amount of fusing agent or binder agent specified in control instructions for a layer to a threshold. If the amount of fusing or binder agent is substantially greater for the second layer than the first layer, for example greater by more than a threshold amount, this may indicate that a substantially larger area is to be solidified.

If the determination in block 204 is negative, (i.e. the second layer does not comprise a qualifying downwards facing horizontal surface, for example because it is determined that the area to be solidified in each layer is the same, the area to be solidified in the second layer is less than the area in the first layer, or the area to be solidified in the second layer is greater than the area in the first layer by less than the threshold amount), then printing may continue in a bidirectional recoating mode (block 208).

In this example, the method may then loop back to block 202 with the next pair of layers. In this example, the second layer of a previous iteration provides the first layer of a subsequent iteration such that each layer is compared with its immediately succeeding layer. When the condition of block 204 is met, the recoating mode switches to a unidirectional recoating mode.

Once the unidirectional recoating mode has been entered, the method proceeds to block 210, which comprises processing a predetermined number of layers in the unidirectional recoating mode, i.e. by spreading build material across the print bed in the first direction. For example, around 10, 15 or 20 layers may be processed in this manner. The number of layers formed using a unidirectional recoating mode may be associated with an observed reduction in effects such as crazing. This may be related to, for example, one or more of the layer thickness, characteristics of the build material, and characteristics of the recoater mechanism. After the predetermined number of layers have been formed and processed, the method proceeds in block 212 by determining that the next layer is a first layer in a second subset, i.e. a subset in which a bidirectional recoating mode is used. Thus, the method loops back to block 208 for bidirectional recoating and to block 202 to identify the next layer comprising a significant change in the area to be solidified. The method may continue until all pairs of layers have been inspected.

In such examples therefore, the layers are formed as part of a build operation in generating at least one object, and the build operation may comprise a plurality of second subsets of layers and a least one first subset of layers, wherein each first subset of layers comprises a predetermined number of layers and the second subset of layers comprises the remaining layers of the build operation (i.e. the layers which are not formed using a unidirectional recoating mode). In some examples, the processing of data slices may be carried out in advance of object generation. In some examples, the processing of data slices may be carried out during object generation but may be somewhat ahead of the object generation process, such that while layer i is being formed and processed, slice j representing layer j is being analysed, wherein j=i+n, where n may be any integer (for example, 2, 5, 10 or the like). Moreover, while the analysis described in FIG. 2 is carried out for the layer as whole, in other examples it may be carried out in relation to part of a layer, or on an object-by-object basis.

In some examples, if a second determination in block 204 is positive, then the apparatus may again resume unidirectional recoating mode. In such examples, the recoater may spread build material over the print bed in an opposite direction to a previous loop of the method, as is shown in FIG. 3.

In the example of FIG. 3, in a first iteration, in block 302, a unidirectional recoating mode comprises spreading build material across the print bed in a first direction for m layers (where m is any integer, for example between around 5 and 20), before bidirectional recoating is resumed in block 304. If a second iteration triggers unidirectional recoating, then the recoater may consistently spread build material across the print bed in the second direction for this second iteration for m layers (block 306), before bidirectional recoating is resumed in block 308. In this way, where two reservoirs of build material are provided, each will be depleted in a more balanced manner, thereby maximising a build height.

Thus, there may be a first subset of consecutive layers formed by spreading build material over the print bed in the first direction (a first unidirectional recoating mode), a second subset of consecutive layers formed by spreading build material over the print bed in the first and second directions alternately for alternate layers (bidirectional recoating mode) and a third subset of consecutive build material layers formed by spreading build material over the print bed in the second direction for each layer (a second unidirectional recoating mode).

In some examples, the layers are formed as part of a build operation in generating at least one object, and the build operation comprises a plurality of second subsets of layers, a least one first subset of layers and at least one third subset of layers, wherein each first subset of layers comprises a predetermined number of layers, each third subset of layers comprises a predetermined number of layers and the second subset of layers comprises the remaining layers of the build operation.

Moreover, in some examples, the method may switch from operating in the first unidirectional recoating mode directly to operating in the second unidirectional recoating mode. For example, if 20 layers of an object are to be formed in a unidirectional recoating mode, the first ten may be formed in the first unidirectional recoating mode and the second ten may be formed in the second unidirectional recoating mode. While this may somewhat impact the quality of the object being formed (for example during a number of layers prior to or after the change in recoating direction) as the build material spreading direction is reversed, this change in direction is reduced relative to a standard bidirectional recoating mode. Therefore, the quality of the object may be higher than if such a bidirectional mode was used. Moreover, this may distribute the use of build material between different build material reservoirs which may increase the usable build height in a build operation and/or reduce the need for refilling operations, as described above.

In other examples, the number of layers formed using each unidirectional recoating mode may be determined by analysing the intended build operation as a whole. A number of layers may be assigned to each unidirectional recoating mode which is relatively balanced, so as to distribute the use of build material between different build material reservoirs which may increase the usable build height in a build operation and/or reduce the need for refilling operations, as described above.

Moreover, while in the example of FIG. 2, the first layer to be formed including the downwards facing horizontal surface comprises the first layer to be formed using a unidirectional recoating mode, in other examples, the switch to unidirectional recoating mode may be triggered at least one layer before the layer which is to include the surface.

In some examples, in order to extend the benefits provided by applying particular processing parameters to downwards facing horizontal surfaces of an object, virtual objects in a virtual fabrication chamber may be arranged so as to align the downwards facing horizontal surface of at least two objects, wherein a ‘downwards facing horizontal surface’ may be any surface of an object which may be aligned with the plane of a layer in additive manufacturing (or a slice of a virtual fabrication chamber).

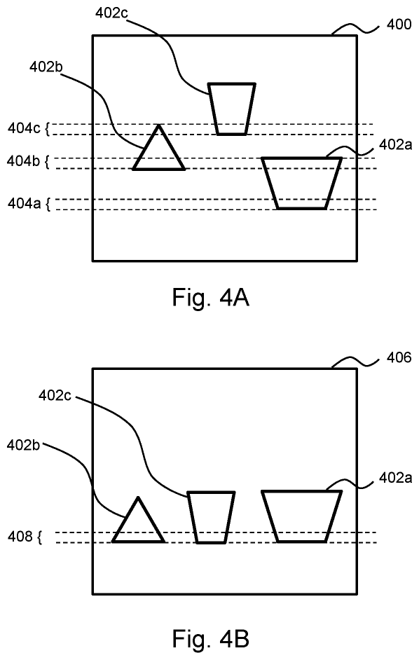

For example, FIG. 4A shows an example of a first virtual fabrication chamber 400, in which a first virtual object 402a, a second virtual object 402b and third virtual object 402c have been placed without consideration of alignment of their bases, wherein in this example the bases provide examples of downwards facing horizontal surfaces. The method of FIGS. 1 to 3 may still be applied to processing this virtual fabrication chamber 400. For example, unidirectional recoating mode may be used in a first set of layers 404a, associated with the base of the first virtual object 402a, a second set of layers 404b associated with the base of the second virtual object 402b and a third set of layers 404c, associated with the base of the third virtual object 402c.

However, FIG. 4B shows an example of a second virtual fabrication chamber 406 in which the first virtual object 402a, second virtual object 402b and third virtual object 402c have been arranged so as to align their bases. More generally, in other examples, the downwards facing horizontal surfaces of objects may be aligned. In this example, the unidirectional recoating mode may be used in just one set of layers 408, as the bases of the virtual objects are aligned.

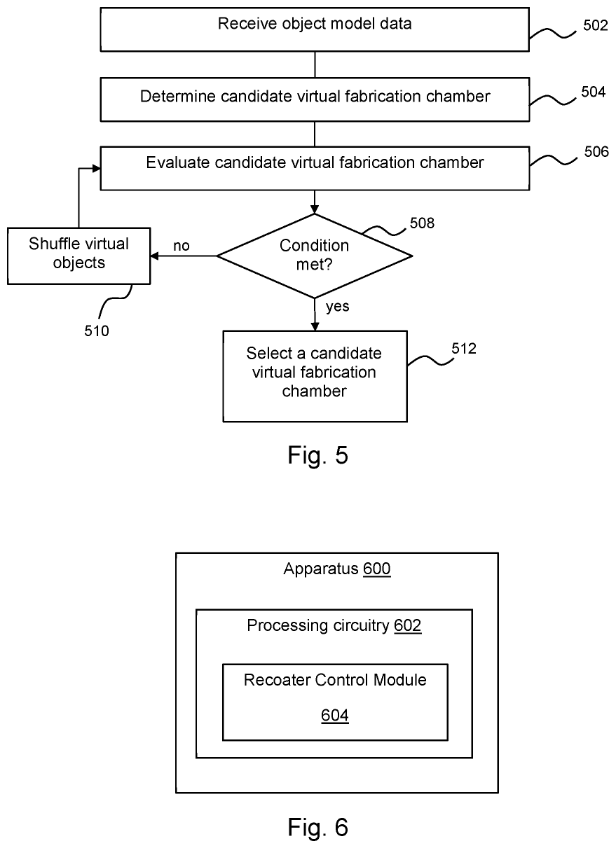

Such alignment may be provided by a user reviewing the intended content of the fabrication chamber and placing the virtual objects in locations such that their bases are aligned. In other examples, so-called ‘packing algorithms’ may be used which set constraints on the placement of objects. In still other examples, as further described below with reference to FIG. 5, a plurality of candidate arrangements modelling different placements of objects may be generated, and each arrangement scored. For example, the virtual objects may be ‘shuffled’ between arrangements using rotations and/or translations in some examples respecting predefined parameters such as being fully contained within a usable build volume and/or having at least a predetermined separation between objects. The score may be based on a number of factors, such as the number of objects included in the arrangement and/or the height of the arrangement (as a smaller overall height can generally result in a faster object generation operation). However, the score may also consider the extent to which a particular build operation may distribute the downwards facing horizontal surfaces of the different objects. For example, the test set out in block 204 may be applied to each pair of layers in an arrangement. An arrangement in which fewer subsets of layers are associated with a unidirectional recoating mode may tend to score better than an arrangement in which more subsets are associated with a unidirectional recoating mode.

FIG. 5 is an example of a method, which may comprise a computer implemented method and/or a method of determining an arrangement of object(s) to be generated within a build volume of an additive manufacturing apparatus. The method comprises determining a plurality of candidate arrangements, which may be referred to as ‘candidate virtual fabrication chambers’ as they model, or virtually represent, a possible placement of object(s) which may be generated in a build volume (i.e. within a fabrication chamber) of an additive manufacturing apparatus.

Block 502 comprises receiving, by at least one processor, object model data. The object model data describes at least a first object to be generated in additive manufacturing, and may in some examples describe a plurality of objects. In some examples, the object model data may be received from a memory, over a network or the like. In some examples, the object model data may describe at least the geometry of object(s) to be generated, for example in the form of a vector model, a mesh model or a voxel model of the object(s). In some examples, the object model data may describe intended object properties, such as color, strength, density and the like.

Block 504 comprises determining, by at least one processor (which may comprise the same processor(s) as performs block 502), a candidate virtual fabrication chamber indicating a possible placement and orientation of a plurality of objects including the first object in object generation.

In other words, the candidate virtual fabrication chamber models an actual build volume (or fabrication chamber) which could result after carrying out an additive manufacturing operation. For example, this may specify the placement of the first object within the build volume (for example, its location in three-dimensional space, which may be expressed using xyz coordinates relative to an origin, which may be defined as a corner of the fabrication chamber), and in some examples, its placement relative to other objects to be generated within the build volume in the same possible object generation operation. The orientation of the object(s) may also be specified. As noted above, the orientation of an object during generation may not be constrained to the intended orientation in use-objects may be generated ‘upside down’, or on their sides or in some other way.

Block 506 comprises evaluating, by at least one processor (which may comprise the same processor(s) as perform block 502 and/or block 504), the candidate virtual fabrication chamber. For example, the evaluation may comprise generating a score for the candidate virtual fabrication chamber based on a predetermined target function. The target function may evaluate any combination of criteria. For example, candidate build volumes may be evaluated to determine that certain criteria are met. For example, the criteria may comprise a determination that the objects are non-overlapping, and that they are separated in space. A threshold separation may be specified to ensure that objects do not unintentionally merge during object generation. In addition, in particular when additive manufacturing processes use or generate heat, objects may be separated to provide at least a degree of thermal isolation between objects. However, in this example, the target function also comprises an evaluation of how many layers will be generated in a unidirectional recoating mode (for example, because they comprise a downwards facing horizontal surface of an object, or in another example because they comprise any object portion).

Block 508 comprises evaluating if a condition has been met. This may comprise for example, a threshold score being achieved, or an indication that a predetermined number of iterations have been made.

If the condition is not met, the candidate virtual fabrication chamber may be ‘shuffled’ in block 510. For example, this may comprise applying a random rotation to virtual object(s) (and in some examples, validating that the new object placement remains inside the printable volume and does not result in an intersection between objects), and the shuffled candidate virtual fabrication chamber is then scored again.

If the condition is met, then a candidate virtual fabrication chamber may be selected for a 3D printing operation based on its score (block 512).

FIG. 6 is an example of an additive manufacturing apparatus 600 comprising processing circuitry 602. The processing circuitry 602 comprises a recoater control module 604. In use of the apparatus 600, the recoater control module 604 determines if a layer to be formed is a first layer of a pair of consecutive layers of build material to be formed by recoating a build platform in a common direction and, if so, the processing circuitry 602 causes the recoater to form a layer of build material by recoating the build platform while moving from a first side of a build platform to a second side of the build platform, and then return to the first side of the build platform without spreading build material. In other words, the processing circuitry 602 causes the apparatus 600 to operate in a unidirectional recoating mode.

In some examples, in use of the apparatus 600, the recoater control module 604 determines that a predetermined number of subsequent layers after the particular layer are to be formed by recoating in the common direction from the first side of a build platform to the second side, and moving the recoater back to the first side without spreading build material. Thereafter, layers may be formed by recoating a build platform from the first side to the second side, and then from the second side to the first side, spreading build material in both directions, to form alternate layers (for example, operating in a bidirectional recoating mode as discussed above). In other examples, at least a number of layers may be formed in a second unidirectional recoating mode, by recoating the build platform with build material while moving the recoater from the second side to the first side to spread build material, then returning the recoater to the second side without spreading build material.

Thus the processing circuitry 602 may comprise a controller of an additive manufacturing apparatus, which controls the apparatus to operate in at least one unidirectional recoating mode for some layers and a bidirectional recoating mode for the other layers.

In some examples, the additive manufacturing apparatus 600 may comprise the build material recoater. In some examples, the additive manufacturing apparatus 600 may comprise the build platform in use. However, the build platform may be a removeable component of the apparatus 600.

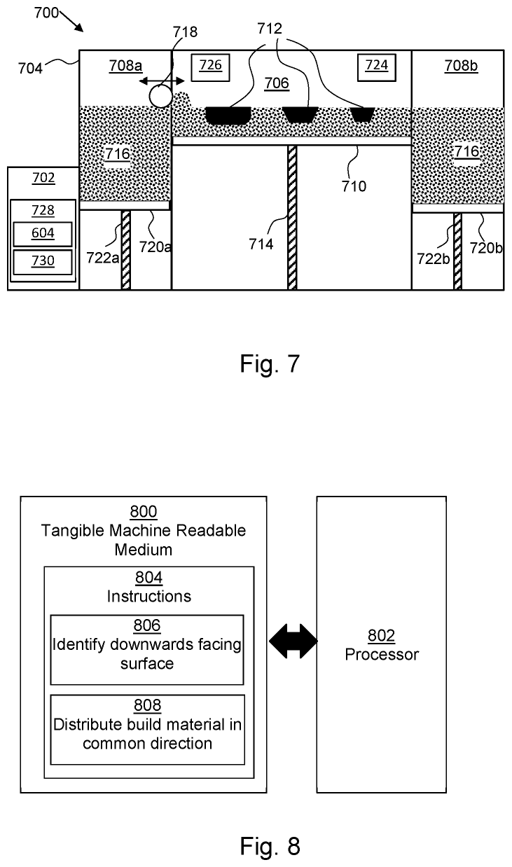

FIG. 7 is an example of an apparatus 700, which in this example is an additive manufacturing apparatus, comprising a controller 702. The additive manufacturing apparatus 700 may be variously referred to as a 3D printer, a 3D printing device and the like

The additive manufacturing apparatus 704 in this example comprises a fabrication chamber 706 (or build chamber), which encloses a build volume, and two build material reservoirs 708a, 708b.

In this example, the apparatus 700 comprises a binder jetting 3D printing system that enables the formation of a 3D object (sometimes referred to as a “green object” or “green part”) in a layer-by-layer build process using a metal powder build material and a binder agent, in this example, a liquid. However, the principles set out herein may be similarly applicable to other systems, including other granular build material bed-based additive manufacturing systems in which layers of granular build material are to be spread over a build platform and processed with print agents to facilitate the solidification of the build material. Furthermore, the apparatus 700 is shown by way of example, and it is not intended to represent a complete 3D printing system. Thus, it is understood that such an example apparatus 700 may comprise additional components and may perform additional functions not specifically illustrated or discussed herein.

The apparatus 700 includes a moveable build platform 710 to serve as the floor to the fabrication chamber 706 as 3D objects 712 are formed. In particular, during the formation of a 3D object or objects within a particular build or print job, build material layers can be spread over the build platform 710 using different spreading parameters (i.e. unidirectional recoating or bidirectional recoating) for different layers of the object or objects. The build platform 710 is movable in a vertical direction (i.e., up and down) by a lift mechanism 714. A build volume is enclosed within the fabrication chamber 706 having walls that surround the build platform 710 to contain build material 716 spread over the platform 710 during a build process. In the view shown in FIG. 7, the front wall of the apparatus 700 is not shown in order to provide a better view of other components, objects, and materials inside the fabrication chamber 706. In this example, the build material 716 is a powder-like granular material. However, in principle the build material may for example comprise a slurry, liquid, a paste, or a gel.

The example apparatus 700 includes two build material supply reservoirs 708a, b to provide build material 716. During a build process, a recoater 718, in this example a rotating roller, translates over the build platform 710 as indicated by the direction arrow. The recoater 718 is capable of moving build material 716 from either reservoir 708a, b, spreading it in a layer over the build platform 710 on top of a previous layer. With each new layer, a build material delivery platform 720a,b driven by lift mechanism 722a, b in one of the reservoirs 708a,b can push more build material upward, making the build material available to the recoater 718. After each new build material layer is spread over the build platform 710 and processed with liquid agent and heat, as discussed below, the build platform 710 can move downward, making room in the fabrication chamber 706 for a next layer. This may also allow the recoater 718 to travel back over the build platform 710 without interacting with a previously formed build material layer when operating in a unidirectional recoating mode. As mentioned above, in other examples, build material may be provided in some other way. For example, build material may be fed onto the build platform 710 or previously formed layer from a build material dispenser which scans across the build platform 710. In such an example, build material may be distributed over one dimension (e.g. a width or length) of the build platform 710, and may form a ridge in front of the recoater (e.g., a rotating roller, blade, scraper or the like, which may in some examples be vibrated) moving in an orthogonal direction to the ridge of build material. This ridge of material may be spread, i.e. flattened and/or compressed by the motion of the recoater to form a layer of build material for further processing.

A liquid agent dispenser 724 can deliver a liquid functional agent such as a binder liquid or a liquid fusing agent and/or detailing agent in a selective manner onto areas of a build material layer that has been spread over the build platform 710. Areas of build material layers that are to be printed can be determined in accordance with a digital 3D model that includes geometric information describing the shape of the object(s) to be printed. As described above, such a model, or ‘virtual fabrication chamber’ can be processed into slices, where each slice defines the portions of a build material layer that are to be printed on by the liquid agent dispenser 724 in order to form a layer of the 3D object(s) 712. A liquid agent dispenser 724 can include, for example, a printhead or printheads, such as thermal inkjet or piezoelectric inkjet printheads. In some examples, a liquid agent dispenser 724 can comprise a platform-wide array of liquid ejectors (e.g., nozzles, not shown) that spans across the width of the build platform 710. For example, a platform-wide liquid agent dispenser 724 can move bidirectionally above the build platform 710 as it ejects liquid droplets onto a build material layer.

In this example the apparatus 700 also includes a thermal energy source 726 such as a thermal radiation source. The thermal energy source 726 can apply radiation to heat build material layers on the build platform 710. In some examples, the thermal energy source 726 can comprise a platform-wide scanning energy source that scans across the build platform 710. Additional or alternative thermal energy sources can include, for example, resistive heating elements disposed within walls of the fabrication chamber 706 or the build platform 710.

As mentioned above, in this example, the apparatus 700 also includes a controller 702. The controller 702 can control various components and operations of the apparatus 700 to facilitate the printing of 3D objects as generally described herein, such as controllably spreading powder onto the build platform 710, selectively applying/printing print agent onto portions of the build material 716 and exposing the build material 716 to radiation.

Moreover, in this example, the controller 702 can cause the recoater 718 to transition between operating in a unidirectional recoating mode and a bidirectional recoating mode. The example controller 702 may control components of the apparatus 700 to perform operations such as discussed with reference to FIGS. 1-6.

In this example, the controller 702 comprises processing circuitry 728. The processing circuitry 728 comprises the recoater control module 604 as described in relation to FIG. 6. In addition, the processing circuitry 728 comprises a data analysis module 730. In use of the apparatus 700, the data analysis module 730 determines, from data representing an additive manufacturing operation, when an area to be solidified in at least part of a particular layer is greater than the area to be solidified by a corresponding part of an immediately preceding layer by more than a threshold amount; and if so, the recoater control module 604 is to determined that the particular layer is the first layer of a unidirectional recoating mode of build material distribution. However, as discussed above, in other examples there may be other triggers which cause the controller 702 to control the recoater 718 to operate in a unidirectional recoating mode.

In use of the apparatus 700, the build material 716 may be supplied to the fabrication chamber 706 from one or the other of the build material reservoirs 708a, b. In a bidirectional build material distribution mode, each layer is formed alternately from build material 716 from each reservoir 708a, b. In a unidirectional build material distribution mode, each of a plurality of successive layers is formed from build material 716 taken from one of the reservoirs 708a, b. In some examples, each time a unidirectional build material distribution mode is entered, the controller 702 makes a selection of which direction the recoater 718 should move across the build platform 710 while carrying out the recoating action. For example, these directions may alternate as described in relation to FIG. 3 such that each of the reservoirs 708a, b may be used in turn to supply build material 716 such that they deplete in a relatively consistent manner. In other examples, it may be determined which reservoir 708a, b contains more build material and that reservoir 708a, b may be selected for use in a unidirectional build material distribution mode. In other examples, the direction may be selected in some other way.

The processing circuitry 602, 728 in FIG. 6 and/or FIG. 7 may carry out any or any combination of the blocks of FIG. 1, 2, 3 or 5, and/or may process virtual objects to determine a virtual fabrication chamber in which the downwards facing horizontal surfaces of at least two objects are aligned as described in relation to FIG. 4A and B.

FIG. 8 is an example of a tangible machine-readable medium 800 associated with a processor 802. The machine-readable medium 800 stores instructions 804 which, when executed by the processor 802, cause the processor 802 to carry out tasks. In this example, the instructions 804 comprise instructions 806 to cause the processor 802 to identify a downwards facing horizontal surface of a virtual object modelling at least one object to be generated in additive manufacturing. For example, this may comprise identifying a difference in area to be solidified between one layer and the next, as described above. In some examples, it may be determined if the downwards facing surface is of at least a threshold size. The instructions further comprise instructions 808 to cause the processor 802 to control a build material distribution apparatus (e.g. a recoater as described above) of an additive manufacturing apparatus to sweep build material across a build platform in a common direction for each of a predetermined number of layers, wherein the layers are to form the downwards facing horizontal surface and a plurality of layers formed consecutively thereafter. In some examples, at least one layer is formed in the common direction before the layer which is to include the downwards facing surface is formed. In other words, the instructions cause the apparatus to operate in a unidirectional recoating mode to form at least some layers of an object which include a downwards facing surface. As noted above, the term ‘downwards facing horizontal surface’ refer to an object in its intended orientation of manufacture, and may be any surface of an object aligned with a layer, whether or not part of that object has already been processed. In some examples, a downwards facing surface may be any portion which, during the build operation, does not comprise underlying solidified build material and in some examples is of at least a threshold size.

In some examples, the instructions 804 further comprise instructions to cause the processor 802 to, after the predetermined number of layers, control the build material distribution apparatus to form each of a plurality of layers by sweeping build material across the build platform in alternating directions. In other words, the apparatus may operate in a bidirectional recoating mode.

In other examples, the instructions 804 further comprise instructions to cause the processor 802 to, after the predetermined number of layers, control the build material distribution apparatus to form each of a plurality of layers by sweeping build material across the build platform in a second common direction. In other words, the apparatus may operate in a first unidirectional recoating mode and a second unidirectional recoating mode. In some such examples, the apparatus may then switch to a bidirectional recoating mode, for example after a predetermined number of layers.

In some examples, instructions stored on a machine-readable medium may comprise instructions to carry out any or any combination of the blocks of FIG. 1, 2,3 or 5, and/or to process virtual objects as described in relation to FIG. 4A and B.

In the examples above, an apparatus is controlled between operating in a unidirectional recoating mode and operating in a bidirectional recoating mode.

Switching between a unidirectional and a bidirectional recoating mode according to the methods described herein may enable the generation of 3D objects with improved visual and mechanical properties by improving layer quality and/or reducing crazing and other defects without unduly compromising build time and/or build height. Using a unidirectional recoating mode for layers associated with a downwards facing horizontal surface of an object may be particularly suited to reducing defects such as crazing. For the remaining layers of an object, it may be appropriate to revert to bidirectional spreading of build material. For example, after spreading layers in the start-up region of an object (e.g., the first 5, 10 or 20 layers or the like) in a unidirectional manner, the subsequent layers may be formed in a bidirectional manner, i.e., alternating between layers formed by the recoater moving across the print bed in a first direction and layers formed by the recoater moving across the print bed in the opposite direction

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that various blocks in the flow charts and block diagrams, as well as combinations thereof, can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus functional modules of the apparatus and devices (such as the processing circuitry 602, 728, the controller 702, recoater control module 604 or the data analysis module 730) may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine-readable instructions may also be stored in a computer readable storage that can guide the computer or other programmable data processing devices to operate in a specific mode.

Such machine-readable instructions may also be loaded onto a computer or other programmable data processing device(s), so that the computer or other programmable data processing device(s) perform a series of operations to produce computer-implemented processing, thus the instructions executed on the computer or other programmable devices realize functions specified by block(s) in the flow charts in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
forming build material layers over a build platform of a 3D printing device using a build material recoater to spread build material; and
processing at least some layers according to data describing at least one object to be generated in additive manufacturing to form the at least one object, wherein forming the build material layers comprises:
forming a first subset of consecutive build material layers by spreading build material over the print bed in a first direction for each layer; and
forming a second subset of consecutive build material layers by alternating between spreading build material over the print bed in the first direction and a second direction for consecutive layers.

2. A method as claimed in claim 1 wherein the first subset of consecutive build material layers are processed to form layers of at least one object comprising a downwards facing horizontal surface.

3. A method as claimed in claim 1 further comprising, by processing apparatus:
identifying downwardly facing horizontal surfaces of an object;
determining that a plurality of layers comprising the downwardly facing horizontal surfaces comprise layers of the first subset.

4. A method as claimed in claim 3 wherein identifying a downwardly facing horizontal surface of an object comprises:
receiving, from data describing at least one object to be generated in additive manufacturing in a plurality of layers, data describing an intended content of a first layer and a second layer, wherein the second layer is to be formed directly on top of the first layer;
comparing an area to form part of an object in at least part of the first layer and the second layer; and
when the comparison determines that the area to form part of an object in the second layer is greater than the area to form part of an object in the first layer by more than a threshold amount, determining that the second layer comprises a downwardly facing horizontal surface.

5. A method according to claim 4 wherein comparing the area to be solidified comprises determining a difference between a number of pixels in data characterising a region to form part of an object in the first layer and number of pixels in data characterising a region to form part of an object in the second layer.

6. A method as claimed in claim 1 further comprising:
forming a third subset of consecutive build material layers over the build platform by spreading the build material in the second direction for each layer.

7. A method according to claim 6 wherein the layers are formed as part of a build operation in generating at least one object, and the build operation comprises a plurality of second subsets of layers, at least one first subset of layers and at least one third subset of layers, wherein each first subset of layers comprises a predetermined number of layers, each third subset of layers comprises a predetermined number of layers and the second subset of layers comprises the remaining layers of the build operation wherein, during a build operation, a selection is made between forming a first subset of layers and a third subset of layers to distribute use of build material from different build material reservoirs.

8. A method according to claim 1 comprising, by processing circuitry, arranging virtual objects in a virtual fabrication chamber so as to align downwards facing horizontal surfaces of at least two objects.

9. Additive manufacturing apparatus comprising processing circuitry, the processing circuitry comprising:
a recoater control module to determine if a layer to be formed is a first layer of a pair of consecutive layers of build material to be formed by recoating a build platform in a common direction and, if so:
cause the recoater to form a layer of build material by recoating the print bed from
a first side of a build platform to a second side of the build platform; and,
cause the recoater to return to the first side of the build platform without recoating the print bed with build material.

10. Additive manufacturing apparatus according to claim 9, the processing circuitry further comprising:
a data analysis module to determine, from data representing an additive manufacturing operation, when an area to be solidified in at least part of a particular layer is greater than the area to be solidified by a corresponding part of an immediately preceding layer by more than a threshold amount; and if so, the recoater control module is to determine that the particular layer is the first layer.

11. Additive manufacturing apparatus according to claim 10, wherein the recoater control module is further to determine that a predetermined number of subsequent layers after the particular layer are to be formed by moving the recoater control module in the common direction and after the predetermined number of subsequent layers, the recoater control module is to control the recoater to recoat the build platform for each of a plurality of layers by spreading build material across the build platform in alternating directions.

12. Additive manufacturing apparatus according to claim 9 further comprising the recoater.

13. A tangible machine-readable medium storing instructions which, when executed by a processor, cause the processor to:
identify a downwards facing horizontal surface of a virtual object modelling at least one object to be generated in additive manufacturing; and
control a build material distribution apparatus of an additive manufacturing apparatus to sweep build material across a build platform in a common direction for each of a predetermined number of layers, wherein the layers are to form the downwards facing horizontal surface and a plurality of layers formed consecutively thereafter.

14. A tangible machine-readable medium according to claim 13 storing further instructions which, when executed by a processor, cause the processor to:
after the predetermined number of layers, control the build material distribution apparatus to form each of a plurality of consecutive layers by sweeping build material across the build platform in alternating directions.

15. A tangible machine-readable medium according to claim 13 storing further instructions which, when executed by a processor, cause the processor to:
after the predetermined number of layers, control the build material distribution apparatus to form each of a plurality of consecutive layers by sweeping build material across the build platform in a second common direction.
